(19) United States
(12) Patent Application Publication
(10) Pub. No.: US 2026/0235064 A1
(43) Pub. Date: Aug. 13, 2026

(54) FEEDING AND EXHAUST SYSTEM FOR INTERNAL COMBUSTION ENGINE, OR THERMAL UNIT, AND RESPECTIVE METHOD OF OPERATION

(71) Applicant: RHAPIS S.R.L., Collazzone PG (IT)

(72) Inventor: Giulio ROSSI, Collazzone PG (IT)

(21) Appl. No.: 19/151,323

(22) PCT Filed: Feb. 1, 2024
(86) PCT No.: PCT/IB2024/050921

§ 371 Date: Jul. 27, 2025

(30) Foreign Application Priority Data
Feb. 1, 2023 (IT) 102023000001620

(51) Int. Cl. F01N 3/34; F01N 3/00; F01N 3/021; F01N 3/20; F01N 3/30; F01N 11/00

(52) U.S. Cl. CPC F01N 3/34; F01N 3/005; F01N 3/021; F01N 3/2006; F01N 3/206; F01N 3/306; F01N 11/007

(57) ABSTRACT

Feeding system (1) for internal combustion engine (100), or thermal combustion unit, operating with fuel based on hydrocarbons or their derivatives and having at least one intake portion (101) for entering the fed gas into said combustion engine (100) or into said thermal combustion unit, and at least one exhaust portion (102) for exiting exhaust gas from said combustion engine (100) or from said thermal combustion unit, said system (1) comprising at least one sensor (3) for measuring the oxygen content of said exhaust gas coming out of said exhaust portion (102) and at least one exhaust line (2) fluidically connected to said exhaust portion (102) and being provided with a device (4) for cooling the exhaust gas and condensing the water vapor contained in said exhaust gas coming out of said exhaust portion and passing through said exhaust line (2), said system (1) being characterized by further comprising at least one recirculation pipeline (10) for fluidically connecting said exhaust line (2) to said inlet portion (101) of said combustion engine (100) or of said thermal combustion unit, and by comprising means (20) for injecting oxygen, or an oxygen mixture, into said recirculation pipeline (10) for transforming said exhaust gas at the outlet of said exhaust line into said fed gas, wherein the amount injected of oxygen is established depending on the oxygen content of said exhaust gas measured by said at least one sensor for measuring the oxygen content, said feeding and exhaust system further comprising purifying means for purifying said exhaust gas along said exhaust line (2) for eliminating further liquid and/or solid and/or gaseous combustion products contained in said exhaust gas.

### FIELD OF THE INVENTION

The present invention concerns a feeding and exhaust system of an internal combustion engine, or thermal unit, and the respective method of operation. In particular, such feeding system is particularly adapted in the field of eliminating pollutants in the combustion gases generated by an internal combustion engine, whether of the diesel cycle or Otto cycle of the supercharged or atmospheric two-stroke and 4-stroke type, or produced by a thermal unit which generates combustion, such as for example, a boiler (for example LPG, diesel or methane) or a coal-fired thermal-electric power station or other thermal combustion unit.

### KNOWN PRIOR ART

It is known that current feeding and exhaust systems in use allow, downstream of the combustion engine or of a thermal combustion unit, to treat and purify exhaust gases generated by endothermic engines or thermal units or other apparatuses of any size or location which use the combustion of liquid, gaseous or solid substances by using centrifuges, traps, coolers, afterburners, condensers, catalysts, active carbons, chemical substances and HEPA filters, but none of these can ensure, i.e. in the environment, the capture and/or conversion of 100% of the harmful substances present in the gases themselves.

The use of systems which significantly reduce the harmful substances emitted by an internal combustion engine is also known.

For example, Patent WO2021198943, in the name of the applicant, provides for the presence, downstream of the exhaust of an internal combustion engine, of a cooling device which allows to condense exhaust gases by depriving them of water, by means of a forced thermal shock. The water, advantageously reused and nebulized upstream of the cyclones, succeeds in trapping both part of dust trapped precisely in the condensed water and gases, such as CO and CO₂, which remain dissolved and trapped precisely in the water resulting from the condensation of the water vapor contained in the exhaust gases. Successively, the exhaust gas reaches an air/water separator which allows to completely separate the gas from the water, which water can then possibly be filtered and reused or stored in a tank and then disposed of. Once past the gas/water separator, the exhaust gas crosses other filters, such as active carbon filters and HEPA H14 filters, or greater, to eliminate any microparticles that escaped the previous filtering steps.

Also such solution, although extremely effective, does not allow to exclude the complete elimination of the NOx gases, which are extremely harmful to people's health.

Document WO2010/092684, in the name of TOYOTA MOTOR CO LTD, describes an engine of the operating gas circulation type which is provided with a combustion chamber inside which an oxidizing agent (oxygen), a fuel of the hydrogen type, which generates water vapor when burned together with the oxidizing agent, and an operating gas, which has a specific heat ratio higher than air, are fed and in which the operating gas can expand during the combustion of fuel and which engine can let out the water vapor and the operating gas as exhaust gas after the fuel combustion. Such engine further comprises a circulation path able to circulate the operating gas contained in the exhaust gas from the exhaust side to the intake side of the combustion chamber and which provides the operating gas back to the combustion chamber, and a condensing means provided in the circulation path, which means is capable of condensing the water vapor contained in the exhaust gas for transforming water vapor into condensed water. Furthermore, the engine further comprises a means able to contain the condensed water, a pumping means for pumping the condensed water contained in the means containing condensed water at a pressure greater than the atmospheric one, and evaporating means for evaporating the condensed water by means of the exhaust heat of the exhaust gases. This way, the condensed water can be treated appropriately.

Object of the present invention is therefore to make a feeding and exhaust system of an internal combustion engine, or of a thermal combustion unit, fed with diesel, e-fuel or petrol or other fuels based on hydrocarbons and derivatives thereof and which allows to completely eliminate any harmful substances emitted into the atmosphere by the engine or the thermal unit itself.

Further object of the present invention is to make a feeding and exhaust system which is also structurally simple.

Finally, object of the present invention is to implement a method which allows to simply and effectively solve the problems of internal combustion engines, or thermal combustion units (such as boilers or similar devices) related to the emission of harmful substances and gases into the atmosphere.

### SUMMARY OF THE INVENTION

These and further objects are achieved by means of a feeding and exhaust system for internal combustion engine, or thermal combustion unit, operating with fuel based on hydrocarbons or their derivatives, preferably a fuel selected from petrol, e-fuel, diesel and LPG, and having at least one intake portion for entering the fed gas into said combustion engine or into said thermal unit, and at least one exhaust portion for exiting exhaust gas from said combustion engine or from said thermal combustion unit, said system comprising at least one sensor for measuring the oxygen content of said exhaust gas coming out of said exhaust portion and at least one exhaust line fluidically connected to said exhaust portion and being provided with a device for cooling the exhaust gas and condensing the water vapor contained in said exhaust gas coming out of said exhaust portion and passing through said exhaust line, said system being characterized by further comprising at least one recirculation pipeline for fluidically connecting said exhaust line to said inlet portion of said combustion engine or of said thermal combustion unit, and by comprising means for injecting oxygen, or a mixture thereof, into said recirculation pipeline for transforming said purified exhaust gas at the outlet of said exhaust line into said fed gas, wherein the amount injected of oxygen, or of a mixture thereof, is established depending on the oxygen content of said exhaust gas measured by said at least one sensor for measuring the oxygen content, said feeding and exhaust system further comprising purifying means for purifying said exhaust gas along said exhaust line for eliminating further liquid and/or solid and/or gaseous combustion products contained in said exhaust gas.

Such solution allows to achieve the objects suggested. In fact, thanks to this feeding and exhaust system, internal combustion engines, or thermal combustion units, will not generate emissions into the atmosphere since the exhaust gases formed from the combustion of only oxygen and fuel based on hydrocarbons, in adequate proportions, are continuously filtered and reintroduced into the combustion engine, or thermal unit, after having been purified by purifying means and deprived of the water vapor contained therein, and then enriched with oxygen or a mixture thereof, i.e. by injecting a comburent. The oxygen concentration emitted into the purified exhaust gas will depend on the one detected by a concentration sensor (or also known as Lambda sensor) arranged right after the exhaust portion of the internal combustion engine, or thermal combustion unit. Obviously, the feeding and exhaust system also helps to reduce the temperature of the exhaust gases at the outlet of the combustion engine, or thermal combustion unit, and to simultaneously reduce its mass by eliminating the water vapor present therein.

Furthermore, the purifying means allow to eliminate all unburned solid and liquid particles and all the exhaust gases, such as CO₂ and CO, present in the exhaust gas itself.

It should be noted that, when burning, fuels based on hydrocarbons, such as petrol for example (although the arguments are also identical for diesel, LPG or other similar fuels), mainly develop water in the form of vapor (H₂O), unburned hydrocarbons (HC) and carbon dioxide whenever a conventional fuel is used, zero carbon dioxide or unburned solid and gaseous substances whenever e-fuel is used. Both the water and any carbon dioxide generated, as well as unburned solid or gaseous substances resulting from the combustion, can however be captured by the combined operation of the cooling and condensing device and purifying means in order to feed a purified gas which substantially maintains the same flow rate into the intake portion.

Although not described, as is known, the internal combustion engine also comprises an injection system for injecting said fuel based on hydrocarbons or their derivatives. By injecting fuel, or directly within the combustion chamber of the engine, the combustion with oxygen can occur in a known way within the combustion chamber of the internal combustion engine.

The fuel used in the system according to the invention is, for example, petrol, e-fuel, diesel, methane or liquefied petroleum gas.

Furthermore, said injecting means comprise at least one injection line, at least one injector arranged along said injection line and at least partly into said recirculation circuit, and at least one dosing valve arranged along said injection line, upstream of said at least one injector, for dosing the amount of oxygen, or a mixture thereof, to be injected through said injector.

The injector is thus arranged at least partly within the recirculation line to transform the exhaust gas, now completely filtered and deprived of the water vapor, into a gas adapted for being fed to the internal combustion engine, or a thermal combustion unit, as defined above (i.e. selected from a boiler or power station or similar).

Still, the system comprises at least one tank for containing oxygen or a mixture of oxygen, wherein said tank is fluidically connected to the injection line, upstream of the dosing valve.

In particular, the system further comprises means for generating oxygen. Such means for generating oxygen are fluidically connected to said tank, or directly to said injection line, upstream of said at least one dosing valve.

According to an embodiment of the invention, said at least one recirculation pipeline comprises at least one expansion vessel for taking the expansion or contraction of the purified exhaust gas into account and, thus, for maintaining as stable as possible a pressure and, moreover, for preventing overpressures which could be limiting for the engine, or thermal unit, or excessive low-pressures, which could make it difficult to feed and combust a new fed gas for the engine, or the unit itself.

Furthermore, the system comprises one or more heater fans arranged along said at least one recirculation pipeline for controlling, depending on the requests and needs, the flow rate and pressure of the gas circulating within the recirculation pipeline. Said heater fans are preferably at least two, one of which is arranged upstream of said at least one injector and one downstream of said at least one injector. In particular, the rotation speed of said one or more heater fans is controlled depending on the flow rate of fed gas needed for the correct operation of the engine.

This allows to be able to increase the flow rate of the fed gas flowing into the intake portion, thus increasing the power of the engine whenever desiring to obtain a given supercharge. All this can be made independently of the number of revolutions of the engine and makes the system of the present invention an active manager of the flow for charging the engine and not a passive flow manager, i.e. dependent on the revolutions of the engine, as is the case for the one referred to in Patent WO2010/092684.

Moreover, the system can preferably comprise at least one purified exhaust gas flow rate meter (or also known as gas mass meter) arranged along the recirculation pipeline.

Moreover, the system can comprise at least one first sensor for measuring the thermodynamic conditions of the purified exhaust gases, which is arranged along said at least one recirculation pipeline downstream of said at least one injector, and at least one second sensor for measuring the thermodynamic conditions of the gas enriched with oxygen, which is arranged along said at least one recirculation pipeline upstream of said at least one injector.

Such first and second sensors for measuring the thermodynamic conditions basically measure the temperature and/or pressure of the purified gas circulating within the recirculation line. In particular, the temperature and pressure of the purified exhaust gas reaching the recirculation pipeline and the temperature and pressure of the fed gas, i.e. of the purified exhaust gas enriched with oxygen and coming out of the exhaust line, are continuously monitored.

Moreover, the feeding and exhaust system comprises a control unit able to control the opening and/or closing of said at least one dosing valve and/or control the operation of said at least one or more heater fans.

In particular, said control unit controls the rotation speed of said one or more heater fans depending on the flow rate of the purified exhaust gas, which flow rate is measured by said purified exhaust gas flow rate meter and/or depending on said sensor for detecting the concentration of oxygen, in order to ensure the best stoichiometric conditions for combustion.

Preferably, said control unit is able to control the opening and/or closing of said at least one dosing valve depending on data coming from said at least one sensor for detecting the concentration of oxygen in order to dose a given amount of oxygen through said at least one injector.

More in detail, such control unit however also acquires data coming from said at least one sensor for measuring the thermodynamic conditions of the gas circulating within the recirculation pipeline and is also able to operate and control the aforementioned means for generating oxygen, whenever present.

According to a further embodiment of the invention, the purifying means comprise, downstream of said cooling device, at least one cyclonic gas/water vapor separator and at least one tank for collecting the condensed water vapor contained in said exhaust gas and separate from said cyclonic gas/water vapor separator.

Moreover, said purifying means further comprise one or more filters arranged along said exhaust line; said one or more filters are preferably arranged downstream of said at least one cyclonic separator. Said one or more filters are preferably selected from active carbon and HEPA (H14 or greater) filters and carbon dioxide filters, and combinations thereof.

Such filters retain solid and gaseous pollutants.

Still, said purifying means comprise, upstream of said cooling device and along said exhaust line, at least one particle separator preferably of the water and/or dry type. Such particle separator is capable of retaining solid/liquid combustion substances, also including water and carbonaceous dust.

Finally, the purifying means comprise at least one injecting device for injecting the water contained in said tank for the condensed water, or the water contained in a storage/reserve container; said at least one water injecting device is arranged along said exhaust pipeline, upstream of said cyclonic separator and/or said particle separator.

In the event of injecting device upstream of the cyclonic separator, it is downstream of the cooling and condensing device.

In the event of injecting device upstream of the particle separator, it is upstream of the cooling and condensing device.

Such device for injecting water in the form of a spray (nebulized) is able to allow most of the carbon dioxide present in the exhaust gas to be captured.

The objects are also achieved by means of a method of operation of a feeding and exhaust system for internal combustion engine, or thermal combustion unit, according to one or more of claims 1 to 16, comprising the steps of:
a) feeding said internal combustion engine, or said thermal combustion unit, with a fed gas through said intake portion;
a′) feeding said internal combustion engine, or said thermal combustion unit, with a fuel based on hydrocarbons or their derivatives, preferably a fuel selected from petrol, diesel, LPG, methane or e-fuel (hydrogen excluded);
b) measuring the oxygen concentration level detected in said exhaust gas at the outlet of said exhaust portion, at the end of the combustion step inside said internal combustion engine between said fed gas and said fuel based on hydrocarbons or their derivatives;
c) cooling and condensing the exhaust gas coming out of said exhaust portion of said internal combustion engine or of said thermal combustion unit, to transform it into a purified exhaust gas;
characterized by comprising the steps of:
d) making said purified exhaust gas coming out of said at least one exhaust line recirculate along at least one recirculation pipeline;
e) injecting oxygen, or a mixture thereof, into said recirculation pipeline for transforming said purified exhaust gas at the outlet of said exhaust line into said fed gas for said internal combustion engine, or said thermal combustion unit, wherein the amount of oxygen injected is established depending on the oxygen content of said exhaust gas measured in said step b); and
the step f) of filtering said exhaust gas after said step c) and before said step d), for eliminating further liquid and/or solid and/or gaseous combustion products contained in said exhaust gas.

Still, in said step e), an amount of oxygen such as to maintain the oxygen concentration of said fed gas at an adequate stoichiometric level is introduced so that the successive combustion occurs within the internal combustion engine, or within said thermal combustion, in an efficient way. For example, an adequate oxygen level of the purified gas could be greater than 5%.

Finally, the method comprises the step g) of measuring the flow rate of the exhaust gas crossing said recirculation pipeline, and the step h) of increasing or reducing the rotation speed of said one or more heater fans depending on said purified exhaust gas flow rate measured in said step g) and/or on the oxygen content of said exhaust gas measured in said step b).

### DESCRIPTION OF THE FIGURES

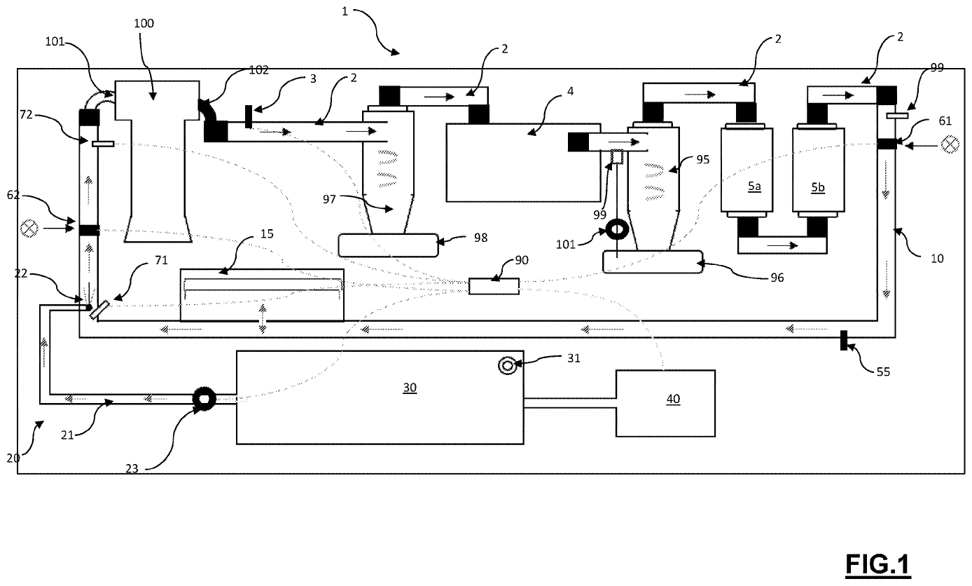

Some particular embodiments of the present invention will now be described, by way of example only and without limitations, with reference to the accompanying figures, in which FIG. 1 is a schematic view of the feeding system according to the invention.

### DETAILED DESCRIPTION OF A PREFERRED EMBODIMENT OF THE PRESENT INVENTION

With particular reference to such figure, a feeding system for internal combustion engine, or thermal combustion unit, according to the invention is denoted by 1.

In the figure shown herein, such feeding system 1 is used in an internal combustion engine 100 which has an intake portion 101 for entering the fed gas into the combustion engine 100 and an exhaust portion 102 for exiting the exhaust gas from the combustion engine 100. It should be observed that the system 1 can also be used in a combustion engine provided with a plurality of feeding portions and a plurality of exhaust portions, without thereby departing from the protection scope of the present invention. The internal combustion engine 100 according to the embodiment described herein is of the diesel type, such internal combustion engine 100 can however also be of the petrol type or anyhow follow a cycle of the supercharged or atmospheric two-stroke and 4-stroke type.

Such internal combustion engine thus comprises, in a known way, an injecting device for injecting fuel based on hydrocarbons, such as for example petrol or e-fuel or diesel or LPG or methane or similar. Such internal combustion engine does not operate with hydrogen.

The fed gas is therefore mixed with the fuel to burn correctly inside the combustion chamber of the internal combustion engine.

Moreover, although neither shown nor described herein, such system 1 can however also be used in a thermal combustion unit of the boiler type, for example, fed with LPG/methane or a coal-fired thermal power station or other thermal combustion unit.

The feeding and exhaust system 1 comprises a sensor 3 for measuring the oxygen content, i.e. concentration, present in the exhaust gas coming out of the exhaust portion 102, commonly also known as Lambda sensor. Moreover, the feeding system 1 comprises an exhaust line 2 fluidically connected to the exhaust portion 102 and provided with a device 4 for cooling the exhaust gas and condensing the water vapor contained in the exhaust gas coming out of the exhaust portion 102 and passing through the exhaust line 2.

Still, said feeding and exhaust system 1 further comprises purifying means for purifying said exhaust gas along the exhaust line 2 for eliminating further liquid and/or solid and/or gaseous combustion products contained in such exhaust gas. As shown in the embodiment described herein, such purifying means preferably comprise one or more filters 5a, 5b arranged downstream of the cooling device 4.

In particular, such filters 5a, 5b comprise an active carbon filter 5a and an HEPA filter 5b.

It should be observed that a different number of active carbon filters and/or HEPA filters would anyhow fall within the protection scope of the present invention.

Such filters 5a,5b have the task of retaining any microparticles present in the exhaust gas.

Although not shown herein, the purifying means can preferably also comprise one or more carbon dioxide filters. Such carbon dioxide filters can be combined with one or more active carbon filters 5a and/or with one or more HEPA filters 5b. Whenever using e-fuel, such one or more carbon dioxide filters are not present in the system 1 since the combustion of e-fuel with oxygen does not generate this gas.

The sensor 3 for measuring the oxygen content, i.e. concentration, present in the exhaust gas coming out of the exhaust portion 102, is advantageously arranged along the exhaust line 2, preferably upstream of the cooling device 4.

Advantageously, the system 1 further comprises a recirculation pipeline 10 for fluidically connecting the exhaust line 2 to the inlet portion 101 of the combustion engine 100. In practice, such recirculation pipeline 10 connects the end of the exhaust pipeline placed downstream of the aforementioned cooling device 4, to the intake portion 101.

The system 1 further comprises means 20 for injecting oxygen into the recirculation pipeline 10 for transforming the exhaust gas at the outlet of the exhaust line 2 into the aforementioned fed gas, wherein the amount of oxygen injected is established depending on the oxygen content of the exhaust gas measured by the sensor 3 for measuring the oxygen content.

In other words, the recirculation pipeline 10 sealingly connects the outlet end of the exhaust line 2 to the intake portion 101 of the engine itself 100, thus achieving a real closed circuit system which, due to its nature, will not be able to release any polluting particle, whether solid or gaseous, and not even the air itself.

The comburent injected can also be in the form of an oxygen mixture, such as for example nitrous oxide or other, which allows to enrich the gas coming out of the exhaust pipeline 2 and reaching the recirculation pipeline 10.

The fed gas taken in by the endothermic engine 100 needs, for its operation, the presence of a comburent substance which is normally constituted by the oxygen present in the air, but the already combusted gas coming out of the engine 100 has a very small amount of oxygen, the presence of means for injecting oxygen, thus the comburent, into the exhaust gas passing along the recirculation pipeline 10 was therefore provided. The amount injected of oxygen will be the one needed for proper combustion to occur within the engine 100 and, thus, adapted to ensure the correct operation of the combustion engine 10 (or thermal combustion unit).

For a proper and prolonged operation of the system 1, there is a need for the presence, along the exhaust line 2, of an appropriate cooling device 4 which allows to decrease the temperature of the exhaust gas and simultaneously eliminate most of the water vapor forming within the exhaust gas as a result of the combustion itself. A cooling device adapted for the purpose is for example described in Patent WO2021198943, in the name of the applicant.

By means of this feeding system 1, the possibility of providing only the comburent needed to the endothermic engine or other equipment and no other substance also naturally present in the air, such as for example nitrogen, will eliminate the production of harmful pollutants such as NOₓ, whose development arises precisely from the combination of nitrogen and oxygen during combustion with the fuel.

The absence of NOₓ to be treated thermally or chemically, as currently achieved by oxidizing catalysts or SCR systems using urea, will also eliminate pollution related to the production, maintenance and use activities of the aforesaid current feeding and exhaust systems.

Furthermore, the injecting means 20 comprise an injection line 21, an injector 22 arranged along the injection line 21 and at least partly into said recirculation circuit 10, and a dosing valve 23 arranged along the injection line, upstream of the injector 22, for dosing the amount of oxygen to be injected through the injector 22.

The amount of oxygen injected will compensate (or replenish) the one burned in the combustion engine 100, thus allowing a stoichiometric concentration with respect to the hydrocarbon fuel injected into the endothermic engine 100 to be achieved such that the engine 100 remains fully operating.

Still, the system 1 comprises a tank 30 for containing oxygen. Such tank 30 is fluidically connected to the injection line 21, upstream of the dosing valve 23. The tank 30 comprises a door 31 for filling the tank 30.

Furthermore, the system comprises means 40 for generating oxygen, also known as oxygen concentrators. Such oxygen generating means 40 are fluidically connected to the tank 30.

In an alternative embodiment not shown herein, the means 40 for generating oxygen can be connected directly to the dosing valve 23.

Still, according to the embodiment described herein, the recirculation pipeline 10 comprises an expansion vessel 15 able to compensate for variations in volume due to increases or decreases in the mass of the gas circulating within the recirculation pipeline itself 10.

Furthermore, always according to the embodiment depicted herein, the system 1 comprises two heater fans 61 and 62 arranged along the recirculation pipeline 10. One heater fan 61 of the two heater fans 61, 62 is arranged upstream of the injector 22 and the other heater fan 62 of the two heater fans 61, 62 is arranged downstream of the injector 22. This way, it is easier to modify both the increase in the flow rate of the fed gas and the possible pressure increase of such gas, whenever desiring to obtain a given supercharge or back-pressure.

Moreover, at least one heater fan is upstream 61 of the expansion vessel 15, while a heater fan 62 is downstream of the expansion vessel 15, so that said feeding and exhaust system 1 can be considered an active dynamic system whose fed gas flow speed is independent of the speed imparted by the revolutions of the engine and/or the combustion pressure.

According to the embodiment described herein, the system 1 also comprises a purified exhaust gas flow rate meter 55 arranged along the recirculation pipeline 10.

Always according to the embodiment described herein, the system 1 comprises a first sensor 71 for measuring the thermodynamic conditions of the gas, arranged along the recirculation pipeline 10 downstream of the injector 22, and a second sensor 72 for measuring the thermodynamic conditions of the gas, always arranged along the recirculation pipeline 10 upstream of the injector 22. The sensors for measuring the thermodynamic conditions 71 and 72 allow to measure pressure and/or temperature of the circulating gas, so that to constantly monitor the thermodynamic conditions of the fed gas and to then be able to appropriately modulate the injection of the comburent into the recirculating pipeline. In particular, the first sensor 71 allows to monitor the thermodynamic conditions of the exhaust gas coming out of the exhaust line 2, while the second sensor 72 allows to monitor the thermodynamic conditions of the exhaust gas enriched with oxygen and to thus transform it into fed gas for the engine 100. Moreover, the exhaust gas coming out of the exhaust line 2 can actually be considered a completely purified gas devoid of possibly harmful substances as well as particulates deriving from the combustion of the fed gas and, anyhow, such as to undermine the efficiency of the successive combustion.

As shown in FIG. 1, the feeding and exhaust system 1 comprises a control unit 90 which, depending on data coming from the sensor for detecting the concentration of oxygen 3, is able to control the opening/closing of the dosing valve in order to dose a given amount of oxygen through the injector 22.

In an alternative way or in combination with the task mentioned above, such control unit 90 is able to control the operation of the said one or more heater fans 61,62.

In particular, the control unit 90 controls the rotation speed of such heater fans 61,62 depending on the air flow rate measured by said air flow rate meter 55 and/or depending on the sensor 3 for detecting the oxygen concentration.

In practice, in the event, for example, of acceleration by the user and thus of a demand for greater power, the control unit 90 shall analyze the purified exhaust gas flow rate and calculate, with respect to such measured flow rate, the one needed to be able to satisfy the power demand of the user, thus increasing the rotation speed of said at least one heater fan (or of both heater fans according to the embodiment described herein). Furthermore, the control unit 90 can also be used for measuring the amount of oxygen detected by the sensor for detecting the concentration of oxygen 3 to improve the speed estimate of the heater fans in order to ensure the oxygen concentration required for the stoichiometric conditions between comburent and fuel to be always optimal for the combustion within the combustion engine 100.

Still, the data detected by the two sensors for measuring the thermodynamic conditions 71 and 72 of the gas, such as temperature and pressure, are stored in the control unit and can be used to control the two heat fans 61 and 62.

Furthermore, the purifying means of the system 1 comprise a cyclonic gas/water vapor separator 95 and a tank 96 for collecting the condensed water vapor contained in the exhaust gas and separate by the cyclonic gas/water vapor separator 95. Such cyclonic separator 95 is preferably arranged downstream of the cooling device 4. In practice, the exhaust gas coming out of the exhaust portion 102 reaches the cooling device 4 where the exhaust gas is brought to a temperature so that to generate the condensation of the water vapor contained in the exhaust gas. Such process also involves trapping carbon dioxide contained in the exhaust gas since the condensed water is able to dilute and/or capture carbon dioxide and eliminate it from the exhaust gas.

In the embodiment described herein, the purifying means comprise, upstream of the cooling device 4 and along the exhaust line 2, a particle separator 97 for separating the particles contained in the exhaust gas from the gas itself. Preferably, such particle separator can be of the water and/or dry type. In other embodiments, the number of such particle separators 97 can also be greater than one and of the air and dry type, without thereby departing from the protection scope of the present invention. Such particle separator is able to filter the solid particles contained in the exhaust gas.

A further tank 98 is also present for collecting the particles separated by the particle separator 97.

Successively, the cyclonic separator 95 separates the exhaust gas from the condensed water of the water vapor. The water vapor is transferred to the tank 96.

The remaining part of the exhaust gas then crosses the active carbon filter 5a and HEPA filter 5b to reach the outlet of the exhaust line 2. In an alternative embodiment, the exhaust gas also crosses one or more carbon dioxide filters.

The aforementioned sensor 3 for measuring the oxygen content of said exhaust gas is arranged along such exhaust line 2, right after the exhaust portion 102 and upstream of the cooling and condensing device 4.

At the end of the exhaust line 2 there is a relief valve 99, which intervenes in the event of overpressures, when for example the pressure inside the exhaust pipeline 2 exceeds 2.5 bars in that point.

Furthermore, the feeding and exhaust system 1 comprises an injecting device 99 for injecting the water contained in the tank 96. Such water injecting device 99 is arranged along said exhaust pipeline 2 upstream of the cyclonic separator 95 and downstream of the cooling and condensing device 4. In another embodiment, the injecting device 99 can be arranged upstream of the particle separator 97. In another alternative embodiment, the number of injecting devices 99 can also be greater than one, for example two in number, and arranged upstream of the cyclonic separator 95 and the particle separator 97, respectively.

Still, in another embodiment, the water reaching the water injecting device 96 can also be collected from a water storage/reserve container (not shown in the figures), instead of from the tank 96, or both. The storage/reserve container is therefore separate from the water tank 96 and is filled by the user instead of the condensed water.

Both in the embodiment mentioned above, in which there is a tank 96, and in the one in which there is a water storage container, the head for reaching the injecting device 99 can be achieved by means of an appropriate pump 101.

The water injected in spray form by the injecting device (or by the injecting devices) is able to capture most of carbon dioxide contained in the gas together with unburned particles present in the exhaust gas.

The now purified exhaust gas, at the outlet of the exhaust pipeline 2 and after having been pushed by a first heater fan 61, passes through the recirculation pipeline 10 where oxygen is injected by means of the injector 22. At this point, the exhaust gas enriched with oxygen crosses the intake portion 101 of the engine 100, thus becoming fed gas for the combustion engine 100. Such fed gas is mixed, in proper stoichiometric proportions, with the hydrocarbon-based fuel injected, for example diesel, or directly in the cylinder of the combustion engine or along the intake line, to burn within the combustion engine 100 itself.

The method of operation of the feeding system 1 for internal combustion engine 100, as described above and anyhow according to one or more of claims 1 to 16, comprises the steps of:
a) feeding the internal combustion engine 100, or a thermal combustion unit, with a fed gas through the intake portion 101;
a′) feeding the internal combustion engine 100, or said thermal combustion unit, with the fuel based on hydrocarbons or their derivatives, such as diesel for example;
b) measuring the oxygen concentration level detected in said exhaust gas at the outlet of said exhaust portion 2, at the end of the combustion step inside the internal combustion engine between the fed gas and the fuel based on hydrocarbons or their derivatives;
c) cooling and condensing the exhaust gas coming out of the exhaust portion 102 of the internal combustion engine 100.

Moreover, the method comprises the step of:
d) making the exhaust gas coming out of the exhaust line 2 recirculate along the recirculation pipeline 10; and
e) injecting oxygen into the recirculation pipeline 10 for transforming such exhaust gas at the outlet of the exhaust line 2 into the fed gas for the internal combustion engine, wherein the amount of oxygen injected is established depending on the oxygen content of exhaust gas measured during step b); and
the step f) of filtering the exhaust gas after step c) and before step d), for eliminating further solid and/or gaseous combustion products contained in said exhaust gas, so that to purify it.

An amount of oxygen such as to maintain the oxygen concentration of said fed gas at an adequate stoichiometric level is introduced into the recirculation pipeline 10 during step e), so that the successive combustion occurs correctly within the internal combustion engine 100 or within the thermal combustion unit.

Finally, the method also comprises the step g) of measuring the flow rate of the exhaust gas crossing said recirculation pipeline 10, and the step h) of increasing or reducing the rotation speed of said one or more heater fans 61,62 depending on the purified exhaust gas flow rate measured in said step g) and/or on the oxygen content of said exhaust gas measured in said step b).

1. Feeding system (1) for an internal combustion engine (100) or a thermal combustion unit operating with fuel based on hydrocarbons or their derivatives and comprising at least one intake portion (101) for entering fed gas into said internal combustion engine (100) or into said thermal combustion unit, and at least one exhaust portion (102) for exiting exhaust gas from said internal combustion engine (100) or from said thermal combustion unit,
said system (1) further comprising at least one sensor (3) for measuring oxygen content of said exhaust gas coming out of said exhaust portion (102) and at least one exhaust line (2) fluidically connected to said exhaust portion (102) and comprising a device (4) for cooling the exhaust gas and condensing water vapor contained in said exhaust gas coming out of said exhaust portion and passing through said exhaust line (2),
said system (1) further comprising at least one recirculation pipeline (10) for fluidically connecting said exhaust line (2) to said at least one inlet portion (101) of said internal combustion engine (100) or of said thermal combustion unit, and injecting means (20) for injecting oxygen, or an oxygen mixture, into said recirculation pipeline (10) for transforming said exhaust gas at the outlet of said exhaust line into said fed gas,
wherein the an amount injected of oxygen is established depending on the oxygen content of said exhaust gas measured by said at least one sensor for measuring the oxygen content, and further comprising purifying means for purifying said exhaust gas along said exhaust line (2) for eliminating further liquid and/or solid and/or gaseous combustion products contained in said exhaust gas.

2. The feeding system according to claim 1, wherein said injecting means (20) comprise at least one injection line (21), at least one injector (22) arranged along said injection line (21) and at least partly into said recirculation pipeline (10), and at least one dosing valve (23) arranged along said injection line (21), upstream of said at least one injector (22), for dosing the amount of injected oxygen, or a mixture thereof, to be injected through said injector (22).

3. The feeding system according to claim 1, further comprising at least one tank (30) for containing oxygen, or a mixture thereof, said at least one tank (30) being fluidically connected to said injection line (21), upstream of said at least one dosing valve (23).

4. The feeding system according to claim 3, further comprising oxygen generating means (40) for generating said oxygen, said oxygen generating means (40) being fluidically connected to said tank (30), or to said injection line (21), upstream of said at least one dosing valve (23).

5. The feeding system according to claim 1, wherein said at least one recirculation pipeline (10) comprises at least one expansion vessel (15).

6. The feeding system according to claim 3, further comprising one or more heater fans (61,62) arranged along said at least one recirculation pipeline (10), said heater fans being at least two, one said heater fan being disposed upstream of said at least one injector (22) and one said heater fan disposed downstream of said at least one injector (22).

7. The feeding system according to claim 6, further comprising at least one purified exhaust gas flow rate meter (55) arranged along said recirculation pipeline (10).

8. The feeding system according to claim 1, further comprising at least one further first sensor for measuring the thermodynamic conditions (71), arranged along said at least one recirculation pipeline (10) downstream of said at least one injector (22), and at least one further second sensor for measuring the thermodynamic conditions (72), arranged along said at least one recirculation pipeline (10) upstream of said at least one injector (22).

9. The feeding system according to claim 7, further comprising at least one control unit (90) able to control the opening and/or closing of said at least one dosing valve (23) and/or control the operation of said at least one or more heater fans (61,62).

10. The feeding system according to claim 9, wherein said control unit (90) controls rotation speed of said one or more heater fans (61,62) depending on the purified exhaust gas flow rate measured by said flow rate meter (55) and/or depending on said sensor for measuring oxygen content (3).

11. The feeding system according to claim 10, wherein said control unit (90) is able to control the opening and/or closing of said at least one dosing valve (23) depending on data coming from said at least one sensor for measuring oxygen content (3) in order to dose a given amount of oxygen through said at least one injector (22).

12. The feeding system according to claim 1, wherein said purifying means comprise at least one cyclonic gas/water vapor separator (95) and at least one water collecting tank (96) for collecting the condensed water vapor contained in said exhaust gas and separated from said cyclonic gas/water vapor separator (95), said cyclonic gas/water vapor separator is arranged downstream of said cooling device (4).

13. The feeding system according to claim 12, wherein said purifying means further comprise one or more filters (5a,5b) arranged along said exhaust line (2), said one or more filters being arranged downstream of said at least one gas/water vapor cyclonic separator (95).

14. The feeding system according to claim 13, wherein said one or more filters are selected from active carbon filters, HEPA filters and carbon dioxide filters.

15. The feeding system according to claim 1, wherein said purifying means comprise, upstream of said cooling device (4) and along said exhaust line (2), at least one particle separator (97) of the water and/or dry type.

16. The feeding system according to claim 14, wherein said purifying means comprise at least one injecting device (99) for injecting the water contained into said water collecting tank (96), or into a storage/reserve container, said at least one water injecting device (98) being arranged along said exhaust pipeline (2), upstream of said cyclonic gas/water vapor separator (95) and/or said at least one particle separator (97).

17. Method of operation of a feeding system for an internal combustion engine or thermal combustion unit, according to claim 6, comprising the steps of:
a) feeding said internal combustion engine, or said thermal combustion unit, with a fed gas through said intake portion;
a′) feeding said internal combustion engine, or said thermal combustion unit, with said fuel based on hydrocarbons or their derivatives;
b) measuring the oxygen concentration level detected in said exhaust gas at the outlet of said exhaust portion, at the end of the combustion step inside said internal combustion engine between said fed gas and said fuel based on hydrocarbons or their derivatives;
c) cooling and condensing the exhaust gas coming out of said exhaust portion of said internal combustion engine or of said thermal combustion unit;
d) making said exhaust gas coming out of said at least one exhaust line recirculate along at least one recirculation pipeline (10);
e) injecting oxygen into said recirculation pipeline (10) for transforming said exhaust gas at the outlet of said exhaust line into said fed gas for said internal combustion engine, wherein the oxygen amount injected is established depending on the oxygen content measured in said step b) of said exhaust gas; and
f) filtering said exhaust gas after said step c) and before said step d), for eliminating further liquid and/or solid and/or gaseous combustion products contained in said exhaust gas.

18. The method according to claim 17, wherein said step e) introduces an amount of oxygen such as to maintain the oxygen concentration of said fed gas at an adequate stoichiometric level so that the successive combustion occurs correctly within the internal combustion engine, or within said thermal combustion unit.

19. The method according to claim 18, further comprising:
g) of measuring flow rate of the exhaust gas crossing said recirculation pipeline; and
h) of increasing or reducing rotation speed of said one or more heater fans depending on said purified exhaust gas flow rate measured in said step g) and/or on the oxygen content of said exhaust gas measured in said step b).

20) The feeding system according to claim 6, wherein at least one heater fan (61) is disposed upstream of said expansion vessel (15) and one heater fan (62) is disposed downstream of said expansion vessel (15).
